(19) United States
(12) Patent Application Publication
(10) Pub. No.: US 2009/0200189 A1
(43) Pub. Date: Aug. 13, 2009

(54) Ladder cap

(76) Inventor: Amanda Sue Fields, San Diego, CA (US)

Correspondence Address: Amanda Sue Fields, P.O. Box 881082, San Diego, CA, 92168, US

(21) Appl. No.: 12/321,224

(22) Filed: Jan. 20, 2009

Related U.S. Application Data
(60) Provisional application No. 61/065,040, filed on Feb. 7, 2008.

(51) Int. Cl. B25H 3/02

(52) U.S. Cl. 206/372

(57) ABSTRACT

A ladder toolbox used to help people who need to carry miscellaneous materials and tools up an A frame ladder and remain safe and hands-free. It consists of four sides slanting upwards to a flat top with handle. It is shaped in a flat topped pyramid style to shape to the form of an A frame ladder. The toolbox has compartments on all four sides that can be removable or permanent. The top is flat with handle and can be used as a resting tray for miscellaneous objects as big as a quart can or small as a tack.

It safely secures over the top of the A frame ladder and all sides come down to the top most ladder step.

### BACKGROUND OF THE INVENTION

1. Field of the Invention

This invention relates generally to a ladder cap and, more particularly, the invention relates to a ladder cap being a portable tool container securable to the top of the ladder itself.

2. Description of the Prior Art

The term “do-it-yourself” applies in its broadest sense to a range of tasks, usually domestic projects of repair or improvement, completed by individuals who are amateurs in the field. Instead of hiring professional contractors, many homeowners enjoy the challenge of learning new skills, adapting individual styles, and incorporating materials and techniques from local sources to beautify and improve their homes. The high degree of personal satisfaction, not to mention cost-of-labor savings, provides substantial incentives to many do-it-yourselfers. A weekend painting project, for example, provides the opportunity to enhance one's self-esteem as well as reduce stress. People who do-it-themselves tend to see themselves as competent, capable, and goal-oriented.

A ladder is an invaluable tool utilized by do-it-yourselfers as well as workers in a plethora of home improvement trades. For such professionals as construction workers, carpenters, contractors, electricians, and painters, these essential devices provide accessibility to ordinarily inaccessible locations. As such, it is often necessary to utilize a wide variety of tools when working on a ladder. However, while working on a ladder, there is no safe place to secure tools in between applications. Should one set the tools down on the ladder's top level, the risk of inadvertently knocking them off and onto the floor below rises dramatically, resulting in irreversible damage to these quite expensive instruments. In addition, a heavy tool falling from a high distance could cause injury to someone who may be standing nearby. While placing the tools on a more stable surface, such as a table or countertop, could conceivably prevent damage to the unit and harm to others, having to climb off the ladder to retrieve a tool every time it is needed could turn a simple, satisfying home improvement project into one that is time consuming and frustrating.

### BRIEF DESCRIPTION OF THE DRAWINGS

FIG. 1 is a perspective view illustrating a ladder cap, constructed in accordance with the present invention; and

FIG. 2 is a perspective view illustrating the ladder cap, constructed in accordance with the present invention.

### DETAILED DESCRIPTION OF THE PREFERRED EMBODIMENTS

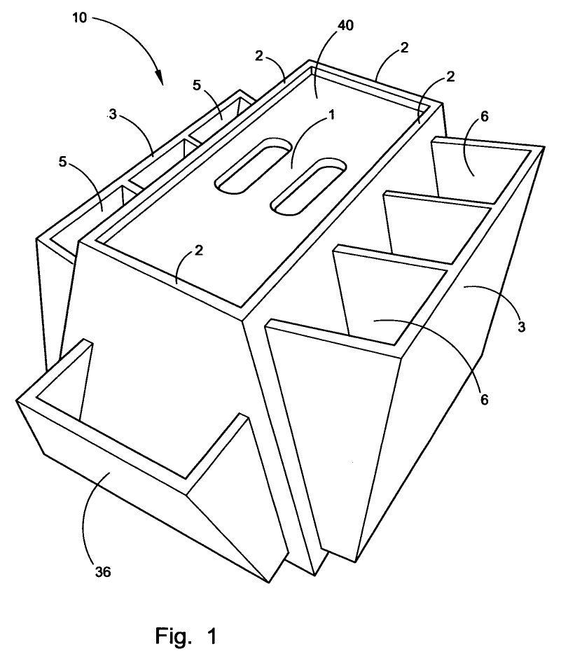

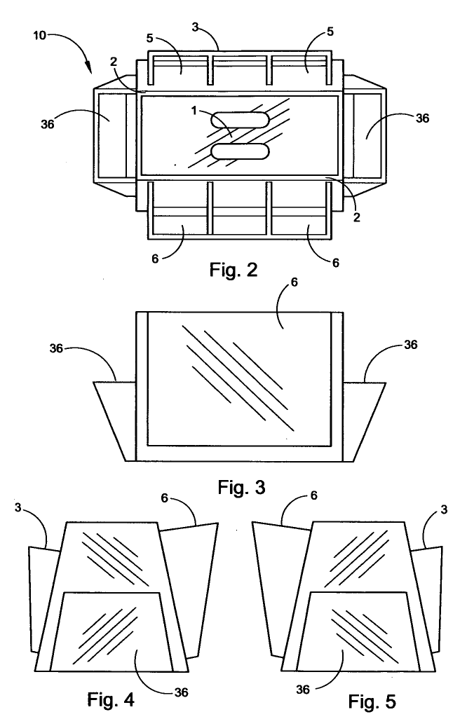

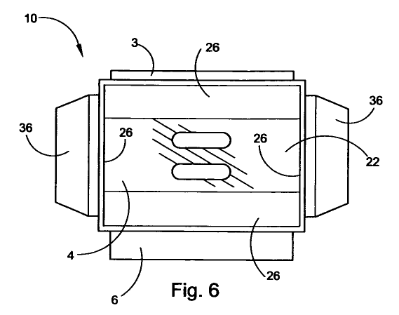

As illustrated in FIGS. 1 and 2, the present invention is a ladder cap offering a convenient solution to the challenges presented when using tools while on a ladder. Simply stated, the ladder cap is a specially designed, portable tool container that can be secured to the top of the ladder itself.

The ladder cap of the present invention is preferably a rectangular, two (2) part durable plastic units that covers the top step of the ladder and contains handy storage bins that flank each side of the top of the ladder. Recessed rectangular niches, the bins. or compartments, are on the side of the ladder facing and preferably measure one and one-quarter inches (1¼″) inches to one and one-half (1½″) inches in length. The bins can be used for storing handled tools, such brushes, paints, art supplies, and putty knives, as well as a plethora of items, such as measuring tapes, screws, nails, and chalk. On the opposing side, paint/artist supplies, screwdrivers, and hammers, can be placed, just to name a few examples. With the ladder cap, the possibilities for storage are virtually limitless. In addition, preferably, each side of the ladder cap tapers upward culminating in a convenient carrying handle to facilitate portability.

Use and application of the ladder cap is very simple and straightforward. First, the user fills the ladder cap with all the necessary tools for a particular job. Grasping the handle on the ladder cap, the user climbs the ladder and sets the ladder cap on the ladder's top step with the ladder cap slipping over the top of an A-frame ladder thereby covering the topmost step of the ladder. In this manner, the ladder cap is steadfastly secured to the ladder and covering only the topmost step staying out of the way of the painter, artist, tradesperson, or do-it-yourselfer and still allowing use of the fold-out tray associated with most A-frame ladders. As the compartments are open, the user can then access any needed tool.

There are several significant benefits and advantages associated with the ladder cap of the present invention. Foremost, the ladder cap provides consumers with an effective, hands-free means of managing and securing tools while working on a ladder. A handy, multicompartmented container that is configured to attach to the top of the ladder, the ladder cap offers efficient storage for practically any tool needed. As a result, those working on ladders have a convenient, safe place to store tools while attending to the task at hand. Alleviating the risk that tools would fall onto the floor, the ladder cap prevents costly replacement of tools as well as possible injury to others. Keeping any desired tool handily within reach at all times, the ladder cap eliminates the need to keep instruments on safer surfaces, allowing users to complete tasks in an easy and expedient manner. While the ladder cap is ideal for the do-it-yourselfer, contractors, construction workers, electricians, painters, and artists will surely appreciate the benefits afforded by this time- and money-saving device. Made of durable, high quality materials, the ladder cap will withstand years of continued use.

An innovative product invention, the ladder cap of the present invention readily enhances the home repair experience. The various compartments of the ladder cap can be filled with paints, water, artist materials, brushes, and any other materials for the painter and artist. Compact and lightweight, the ladder cap proves an invaluable addition to any tool box or utility storage unit.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

FIG. 1

1/3

10—Ladder Cap

1—Handle

2—Ledge rise which circumferences the edge of the top panel.

3—Front and back panels

5—Thinner compartments facing in toward user.

6—Deeper/wider compartments facing away from user.

36—side compartments

40—Tray top panel

FIG. 2

2/3

10—Handle

1—Handle

2—Ledge rise which circumferences the edge of the top panel.

3—Front and back panels

5—Thinner compartments facing in toward user.

36—side compartments

6—Deeper/wider compartments facing away from user.

FIG. 3

6—Panel front facing away from user.

36—Side compartments

FIG. 4

3—Thinner compartments facing in toward user.

6—Deeper/wider compartments facing away from user.

36—Side compartments.

FIG. 5

3—Thinner compartments facing in toward user.

6—Deeper/wider compartments facing away from user.

36—Side compartments.

FIG. 6

10—Ladder Cap

26—Inside view of walls.

36—Side compartments

4—inside of top panel with handle

22—inside view of top panel

3—Bottom view of thinner compartments facing toward user.

6—Bottom view of deeper/wider compartments facing away from user.

This is a continuation of application Ser. No. 61/065,040

The Ladder Cap is a toolbox designed for use atop an A frame ladder. It consists of four main sides consisting of compartments and a flat top rectangle surface with handle. The ladder toolbox is carried by the user up the ladder until the user can safely slide the ladder toolbox up and over the top of the ladder that will be used therefore securing the ladder toolbox over the top of the ladder. The front and back walls of the ladder toolbox will taper upwards to the top of the ladder with the top surface being a flat rectangle surface with a small lip or ledge circumferencing the top edge of the top of the ladder toolbox. The ladder toolbox has compartments on all for sides.

The compartments facing the user while on the ladder are thinner and more narrow as to not interfere with the safety of the user of the ladder while on the ladder. The compartments on the sides and front side facing away of from the user will be wider and will come out further to allow for more items or substances such as paint products. The toolbox will come down on all four sides to the upmost first step of an A frame ladder.

The inside of the ladder toolbox is hollow therefore allowing a secure fit atop the ladder. The ladder toolbox fits down to the upmost top step of the ladder to be used. Compartments which could either be removed to be interchangeable or permanent circumference the toolbox for storage of desired materials. these containers can vary in width and capacity but will always come up almost flush with the top flat area of the ladder toolbox. The containers The top surface of the ladder toolbox is available for use to set objects and containers upon without hindrance of the handle. The handle will either be flat or collapsible. The Ladder Cap needs no fasteners or extra parts to secure itself to the ladder. It is a single piece of durable, lightweight plastic or plastic-like materials.

The top of the ladder toolbox is a flat surface in rectangular shape with a slight ledge or lip around the perimeter of the top of the box.

The Ladder Cap is designed to safely carry and secure items that a person may need to bring up an A frame ladder to perform work tasks.

1. The ladder toolbox assists a person using an A frame ladder to be able to safely climb up a ladder while carrying the ladder toolbox and safely secure the ladder toolbox over the top of the A frame ladder that the person is using. The ladder toolbox needs no fasteners or extra pieces of any kind to secure the ladder toolbox over the top of the A frame ladder. The ladder toolbox consists of four sides angled upwards at a slant to the flat top with handle. Compartments are on all four sides making for easy access to stored materials. Compartments can be either permanent or interchangeable.
